(19) United States
(12) Patent Application Publication
(10) Pub. No.: US 2025/0285012 A1
(43) Pub. Date: Sep. 11, 2025

(54) ARTIFICIAL INTELLIGENCE-BASED AGENT AND FRAMEWORK FOR CONTEXTUALIZED, PRIVATE AND DOMAIN-SPECIFIC OUTPUT DRIVEN BY USER-SPECIFIED CONTENT

(71) Applicant: AGBLOX, INC., IRVINE, CA (US)

(72) Inventors: THOMAS N. BLAIR, IRVINE, CA (US); SEAN FEEHAN, EDMONTON (CA); GREGORY BURLET, EDMONTON (CA); JOSHUA PETER FRANCIS YODER, ROCHESTER, NY (US); KIRILL RAKHMINOV HUGHES, WEST ORANGE, NJ (US); SPYROS J. LAZARIS, LOS ANGELES, CA (US)

(21) Appl. No.: 18/808,045

(22) Filed: Aug. 18, 2024

Related U.S. Application Data
(60) Provisional application No. 63/533,607, filed on Aug. 18, 2023.

(51) Int. Cl. G06N 20/00; G06Q 30/01

(52) U.S. Cl. CPC G06N 20/00; G06Q 30/01

(57) ABSTRACT

A framework provides an approach for utilizing contextualized content from a user's designed set of documents and private data sets to generate customized, contextualized, private, and domain-specific outputs of agents within an artificial intelligence computing environment and a supporting architecture. The agents and artificial intelligence computing environment include augmenting a language model with the contextualized content, and prompting the language model to generate defined, domain-specific outputs. Such agents enable computing systems to execute specific actions identified by a user that are external to the supporting architecture from the defined, domain-specific outputs.

### CROSS-REFERENCE TO RELATED PATENT APPLICATION(S)

This patent application claims priority to U.S. provisional patent application 63/533,607, filed on Aug. 18, 2023, the contents of which are incorporated in its entirety herein. In accordance with 37 C.F.R. § 1.76, a claim of priority is included in an Application Data Sheet filed concurrently herewith.

### FIELD OF THE INVENTION

The present invention relates to the field of artificial intelligence. More specifically, the present invention is a framework for deployment of privately-hosted artificial intelligence models, in which contextualized information from user-specified content augments language models to enable customized actions as domain-specific outputs of artificial intelligence-based agents that leverage such augmented models.

### BACKGROUND OF THE INVENTION

Existing technology for identifying content, and using such content for analysis and augmentation of private data sets encompassed by all of one's universe of documents and files regardless of platform or format, is quite limited. Such existing technology is confined to basic search functions that at best provide a list of files in response to a search, and does not allow for customized identification and extraction of user-specified content from such private data sets.

Artificial intelligence offers some promise for improvements in understanding and augmenting the contents of such data sets. Transformer-based models such as large language models are an artificial intelligence tool that have recently developed and become prominent; however, such models require large-scale, expensive and resource-consuming computing systems for their implementation, and involve highly-customized and complicated builds to be leveraged as base models by follow-on applications. To date, no enterprise-quality applications using such models for analyzing and augmenting a universe of files within a smaller privately-hosted environment have been produced, and there are no such applications that focus on private data sets from user-designated files for driving customized, domain-specific outputs.

Still further, use of such models to enable multi-agent, artificial intelligence-based processing within native operating systems have not been developed. There is therefore a need in the existing art for an approach in which an artificial intelligence-based agent is able operate within one's universe of files and documents, and provide contextualized, dynamic, private and persistent outputs from private data sets within such files and documents. There is a further need in the existing art for a multi-agent approach that is able to operate within smaller computing environments, and across multiple operating systems, to provide deep, artificial intelligence-based analysis and augmentation of private data sets for such contextualized, dynamic, private and persistent outputs.

### BRIEF SUMMARY OF THE INVENTION

The present invention provides a framework for enabling artificial intelligence-based agents, and more specifically agentic systems that are built on top of, and leverage, other complex machine learning tools and artificial intelligence models, to drive customized, contextualized, private, and domain-specific outputs. The framework of the present invention is, in one aspect thereof, an approach for analyzing content within a user's designated set of documents and files through applications of machine learning tools and artificial intelligence models, where contextualized content identified in private data sets in those documents and files is used is augmented by language models, deterministic models, and long-term knowledge graphs, in a privately-hosted environment. This approach is embodied in a framework designed, in a general sense, to enable observability and data analytics for dynamic information discovery. The framework is supported by a software-based data architecture and platform that supports one or more artificial intelligence-based agents to provide semantic, natural language-based functions for searching, contextualizing, analyzing, and executing actions based on the information in private data sets in the user's documents and files to generate defined, domain-specific outputs.

The agents of the framework of the present invention enable computers to execute domain-specific tasks by becoming, in one sense, special-purpose machines that are much more personal to the user, allowing the user to accomplish tasks and actions either with the special-purpose machine itself, or using tools to connect with humans, external systems and/or other machines. The agents of the present invention allow any user to write software for computing systems in manner that allows users to express themselves conceptually, to vastly improve the accessibility and power of both computing systems, and machine learning tools and artificial intelligence models that are becoming increasingly ubiquitous with such accessibility and power.

Still further, the artificial intelligence-based agents of this framework provide a persistent curiosity interface for obtaining the customized, contextualized, private, and domain-specific outputs, and for enabling analytical functions of the user's private data sets. The persistent nature of the curiosity interface allows artificial intelligence-based agents with this framework to remember conversations, queries, searches, and outcomes thereof. The artificial intelligence-based agents and supporting data architecture and platform enable contextual augmentation of large amounts of disparate types of data, regardless of format, type, or particular application.

Objects, embodiments, features, and advantages of the present invention and its embodiments will become apparent from the following description of the embodiments, taken together with the accompanying drawings, which illustrate, by way of example, principles of the invention.

### BRIEF DESCRIPTION OF THE SEVERAL VIEWS OF THE DRAWINGS

The accompanying drawings, diagrams, graphs, and charts, which are incorporated in and constitute a part of this specification, illustrate several embodiments of the invention and together with the description, serve to explain the principles of the invention.

FIG. 1 is a system diagram illustrating elements of an artificial intelligence-based platform supporting an agentic operating environment, according to one aspect of the present invention;

FIG. 2 attached is an exemplary workflow for deploying an artificial intelligence-based agent, according to one embodiment of the present invention;

FIG. 3 is a flow chart illustrating steps in a process for deploying an artificial intelligence-based agent, according to a further embodiment of the present invention; and

FIG. 4 is a data flow diagram for a framework for providing contextualized content for an augmented language model from private data sets according to one embodiment of the present invention.

### DETAILED DESCRIPTION OF THE INVENTION

In the following description of the present invention, reference is made to the exemplary embodiments illustrating the principles of the present invention and how it is practiced. Other embodiments will be utilized to practice the present invention and structural and functional changes will be made thereto without departing from the scope of the present invention.

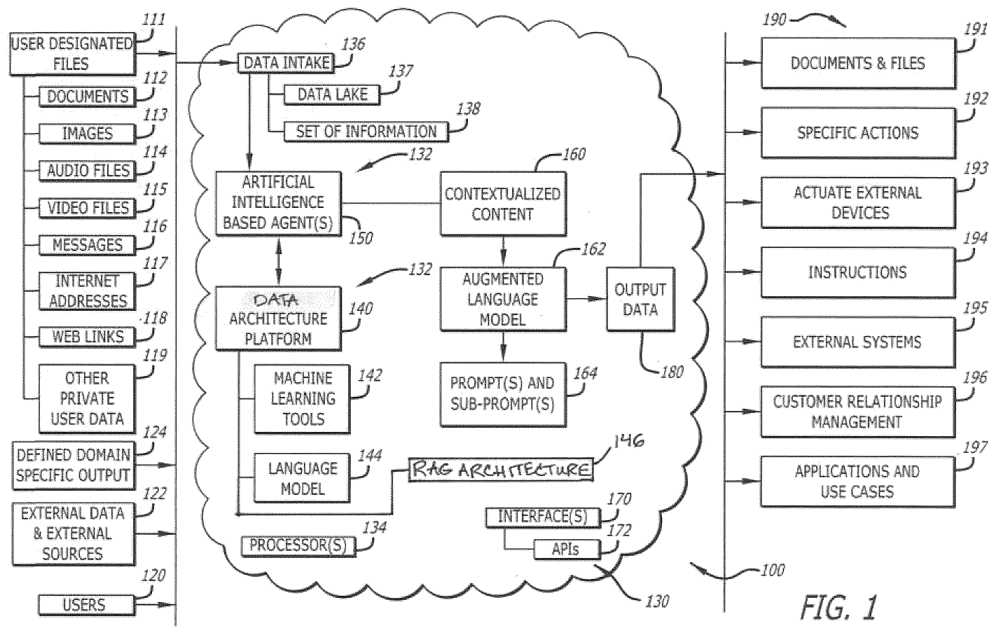

FIG. 1 is a system diagram illustrating elements of a framework 100 for artificial intelligence-based agents 150 according to one aspect of the present invention. The framework 100 includes a data architecture platform 140 that supports an agentic artificial intelligence operating environment in which private data sets among user-designated files 111 are analyzed to drive defined, domain-specific outputs 124 that are highly customized to the private data sets and users 120.

The framework 100 enables analysis of such private data sets to generate contextualized content 160 from within the user-designed files 111 to execute specific actions from the defined, domain-specific outputs 124. These defined, domain-specific outputs 124 are output data 180 in customized, contextualized, and private outcomes of the artificial intelligence-based agents 150. These artificial intelligence-based agents 150 are built on top of machine learning tools 142 and artificial intelligence models 144 such as transformer-based models, which include language models (such as large language models, or LLMs, and “small” language models). Distinctions between sizes of language models 144 are effectively ones of training data set size and of the number of parameters to train models and generate results from natural language queries. Regardless, and for ease of convenience, in the present specification, both large and small language models shall be referred to as language models 144, and it is to be understood that neither the claims nor the disclosure presented herewith shall be limited to a language model 144 of any particular size or type.

Regardless, such defined, domain-specific outputs 124 leverage the content of the sets of information 138 within the user-designed files 111 to accomplish particular domain-specific outputs 124 such as exemplary outcomes 190 of output data 180. The artificial intelligence-based agents 150 of the framework 100, as noted above, are supported by an underlying data architecture and platform 140, as well as in accordance with one or more interfaces 170 for both users 120 and external systems 195 that integrate with the framework 100. The framework 100 and underlying data architecture platform 140 enables multiple artificial intelligence-based agents 150, which may operate either on localized devices or systems, or within cloud computing systems, and within native or isolated operating environments, to deliver any type of contextualized private and domain-specific outcome as output data 180.

The framework 100 may also include one or more application programming interfaces (APIs) 172 that enable various activities of data processing elements 132, including the artificial intelligence-based agents 150. These APIs 172 provide interfaces 170 between various data processing elements 132 within the framework 100, as well as for communicating with external systems 195. For example, artificial intelligence-based agents 150 may integrate with internal APIs 172 at least for intake of sets of information 138 from the data lake 137, populating data collections comprising the knowledge base, and integrating with knowledge graphs, and for certain output functions such as for example generating a transcription of a particular user-designated file 111. Examples of where APIs 172 may be leveraged for communicating with external systems including creating and delivering a short as a document and file 191 to an external system 195 or platform, adding information to a customer relationship management system 196 or database, and sending an instruction 194 to actuate 193 a mechanical system such as robotic equipment. APIs 172 may be native to the framework 100, or in conjunction with external systems 195.

The framework 100 of the present invention is embodied within one or more systems and/or methods that are performed in a plurality of data processing modules 132 that are components within a computing environment 130 that also includes one or more processors 134 and a plurality of software and hardware components. These data processing modules 132 may be configured to run within external cloud computing environments (and accessed therefrom by the framework 100), and also may be configured to run locally on devices hosting the framework 100, such as on mobile computing devices, “smart” phones, earphones or earbuds, on other wearable, internet-enabled devices such watches and eyeglasses, and in automotive platforms. Still further, one or more of the data processing modules 132 may be configured to run within, and executed on, edge computing environments and be responsive to natural language instructions, either verbal, written, or gesture-based. The one or more processors 134 and plurality of software and hardware components are configured to execute program instructions or routines to perform the elements, modules, components, and functions described herein that together comprise and are embodied within the plurality of data processing modules 132. The words “module” and “modules” as used herein, may refer to (and the data processing modules 132 may themselves comprise, at least in part) logic embodied in hardware or firmware, or to a collection of software instructions, written in a programming language, such as, for example, Java, Python, C, or assembly. One or more software instructions for such modules 132 may be embedded in firmware. It will be appreciated that the functional data processing modules 132 may include connected logic modules, such as gates and flip-flops, and may include programmable modules, such as programmable gate arrays or processors. The data processing modules 132 described herein may be implemented as either software and/or hardware modules and may be stored in a storage device. It is to be additionally understood that the data processing modules 132, and the respective components of the present invention that together comprise the specifically-configured elements, may interchangeably be referred to as “components,” “modules,” “algorithms” (where appropriate), “engines,” “networks,” and any other similar term that is intended to indicate an element for carrying out a specific data processing function. The framework 100, and the artificial intelligence-based agents 150, may enable such a computing environment 130 to effect one or more special-purpose machines on which such a computing environment 130 is configured, and may further enable machines on which such a computing environment 130 is configured to themselves act as special-purpose machines as noted above.

At least the supporting data architecture platform 140, machine learning tools 142, and artificial intelligence models 144 are all part of a broader machine learning and artificial intelligence environment within the framework 100. The implementations and applications of this broader machine learning and artificial intelligence environment within the framework 100 enable the processing of private user data in the input data 110 and drive the defined, domain-specific outputs 124 of the framework 100, as well as output data 180 and exemplary outcomes 190 that embody the defined, domain-specific outputs 124. This broader machine learning and artificial intelligence environment enables the artificial intelligence-based agents 150 to further enable computers and computing systems with which the artificial intelligence-based agents 150 are configured to execute domain-specific tasks, and therefore transform those computers and computing systems into special-purpose machines that are much more user-effective by accomplishing tasks and actions either with the special-purpose machine itself, or in conjunction with external systems 195 and/or other machines.

The framework 100 includes multiple implementations of machine learning tools 142. These machine learning tools 142 may include many different techniques of machine learning, such as both supervised and unsupervised learning as well as instantiations of neural networks to continually enhance the data processing functions performed in the framework 100 of the present invention, by developing and understanding relationships between various types of information. The framework 100 also includes multiple additional artificial intelligence (AI) models, which may include standardized models or models developed for particular purposes, such as neural-network-based transformer models that include language models 144, including large language models (LLMs), and may also include one or more models customized according to proprietary formulas. Regardless, the machine learning tools 142 and language models 144 are comprised, at least in part, of algorithms that apply many different mathematical approaches to analyzing information (either structured or unstructured) and generating the defined, domain-specific outputs 124 that provide the customized, contextualized, and private outcomes of artificial intelligence-based agents 150 within the framework 100.

Language models 144 are programs that are able to recognize and generate natural language in text, among other tasks. Large versions of these language models 144 are trained on huge sets of data. Regardless of size (small or large), language models are built using machine learning techniques, such types of neural networks commonly referred to as transformer models. These neural networks include implementations of deep learning techniques for understanding natural language inputs and how characters, words, and sentences function together. Deep learning involves the probabilistic analysis of unstructured data, which eventually enables the neural network to recognize distinctions between pieces of content without human intervention.

Returning to FIG. 1, the framework 100 ingests, receives, requests, or otherwise obtains input data 110 from many different types of sources. Input data 110 may include many different types and formats of information that form user-designed files 111. Input data 110 may include documents 112, images 113, audio files 114, video files 115, and messages 116. Users 120 may also designate input data 110 that includes Internet addresses 117, web links 118, and any other type or format of private user data 119. Input data 110 may also include external data 122 from external sources. Input data 110 may be obtained from any source, and be in any format.

Examples of user-designated files 111 may include, but are not limited to, written documents such as those created or maintained with document creation and management systems such as Microsoft Office™ and Drive™ or Docs™ provided by Google™. Messages 116 may include those created and maintained using messaging systems such as for example Outlook™, Gmail™, Slack™, WhatsApp™, and Viber™ (including, but not limited to, text messages and emails via any platform or provider). User-designated files 111 may further include any other electronic file containing decipherable content (such as for example PDFs, JPEGs, etc.), regardless of whether such files are comprised of structured data, unstructured data, or both. Such user-designated files 111 may also include files collected from virtual meetings platforms in the form of meeting recordings (either audio or video or both), and transcriptions thereof.

The input data 110 may include information provided by the user 120 in the form of queries, instructions, or other approaches to entering information within the framework 100. This type of input data 100 may be verbal, written, or gestured; it may also be determined from real-time interactions or time-lagged interactions, such as for example verbalized or written instructions during a recorded conversation, which occur in real-time or in a prior recording thereof.

The input data 110 may still further include information provided by a user 120 that provides definition for the defined, domain-specific output 124. Such information may be provided via one or more prompts or sub-prompts 164 of an artificial intelligence-based agent 150. This information includes the domain itself—the subject matter for which the artificial intelligence-based 150 is being created to generate the output 124 desired. Domain specificity in the output context may be any type of output 124 desired by the user 120, and may be thought of as the reason for the artificial intelligence-based agent 150. Domains may therefore represent a subject or theme of the artificial intelligence-based agent 150, as well as the subject of its outcome. Specificity of the domain may therefore be constraints or parameters for the domain, and constraints or parameters for the defined, domain-specific output 124 itself. For example, the framework 100 may be implemented to build a ranking agent (i.e. enrollments, mental health risk); an accessibility agent (i.e. notes, summaries); a knowledge base (i.e. patent database questions); shorts (i.e. highlights short video or audio); an assessment agent (i.e. assessment without ranking); a notification agent (i.e. meeting prep email); an agent that generate one or more forms (i.e. RFC response, or a request to perform maintenance on equipment or devices); and an auto-grader agent (i.e. assessment a student's performance on a test). Each of these artificial intelligence-based agents 150 has one or more domain constraints, such as its field, what its function(s) are, what information is to be analyzed, and what its outcome is to be. These domain constraints may be provided to the artificial intelligence-based agent 150 as natural language prompts 164 (either by textual, verbal, or gesture-based entry). Therefore, prompts 164 may be considered as one form of input data 110 for the framework 100. Other ways of introducing domain-specificity may include analysis of the user-designated files 111 by the artificial intelligence-based agent 150; in other words, the artificial intelligence-based agent 150 may learn from prompts 164 while processing user-designated files 111 to create domain-specificity, depending on the circumstances for which it is being asked to analyzed such user-designated files 111.

All of these are types of artificial intelligence-based agents 150 and represent applications and use cases 197 of the framework 100, and it is to be understood that many such applications and use cases 197 are possible and within the scope of the present invention. It is to be further understood that neither the claims herein or the present disclosure are to be limited to any one type of artificial intelligence-based agent 150 or specific application or use case 197 discussed herein.

Domain specificity may also be temporal, in addition to contextual, thematic, and subject driven. For example, an artificial intelligence-based agent 150 may be asked to analyze a particular data set over a specific period of time (for example, last month, last week, last period, last quarter, etc.). Therefore, temporality may also be introduced as a domain constraint of a defined, domain-specific output 124.

It is contemplated that a language model 144 selected for application within an artificial intelligence-based agent 150 may itself be domain specific. In other words, a particular language model 144 may be small and trained on data that is within a specific domain. Therefore, an additional layer of domain specificity may be introduced by the selection of a particular language model(s) 144.

Regardless of type of input data 110 or the form of a user-designed file 111 (or type of external data 122 or defined, domain-specific output 124), information is ingested into the framework 100 by a data intake element 136. This data intake element 136 enables formation of a data lake 137, within which at least the sets of information 138 contained within the user-designed files 111 are maintained and stored, including that which represents the defined, domain-specific output 124.

Prompts 164 may include natural language instructions that are either textual, verbal, or gesture-driven. Prompts 164 may include nested or sub-prompts, and may be provided by a user 120 directly, or may be created by the artificial intelligence-based agent 150 in response to earlier prompts 164 (for example, in the case of nested or sub-prompts). In addition, prompts 164 may be pre-prepared and made available to the user 120 such no textual, verbal, or gestured instruction need be given. The framework 100 may include a roster or set of specific actions 192 that are the result of prompts 164 for defined, domain-specific outputs 124 (such as for example write to customer relationship management system 196, create PDF, send email, grade questions, etc.), and indicia for performing these types of specific actions 192 are available to the user 120, for example as a radio button on interface 170. The user 120 may be able to chain such specific actions 192 together to create a very specific task (or, a very specific defined, domain-specific output 124). In this manner, the user 120 may be able to create prompts 164 without entry of anything at all other than selecting indicia for specific actions 192.

The framework 100 may further include a specific artificial intelligence toolkit that exposes these specific actions 192 along with precise descriptions, or prompts 164, to an augmented language model 162. These prompts 164 for the augmented language model 162 enable the augmented language model 162 to select which of these specific actions 192 are appropriate and then execute those specific actions 192. This paradigm, and this specific artificial intelligence toolkit, enable the framework 100 and an artificial intelligence-based agent 150, to present very specific outcome sets for users 120.

Prompts 164 within the framework 100 may therefore present distinct phases for users 120 within artificial intelligence-based agents 150. In one such phase, the framework 100 presents curated specific actions 192, and allow users 120 to provide artificial intelligence-based agents 150 with domain-specific knowledge, either through prompts 164 or through another interface 170 for providing such knowledge for a defined, domain-specific output 124. In a further phase, the framework 100 allows users 120 to curate their own specific actions 192 and provide prompts 164 within specified domains. And in still a further phase, the framework 100 provides artificial intelligence-based agents 150 in which an augmented language model 162 decides on specific actions 192 based on prompts 164 from users 120 for dynamic tasks that are in addition to the static and repeatable tasks in the defined, domain-specific outputs 124. This enables creation of nested specific actions 192 that are chainable, such that with every building block action created, the artificial intelligence-based agent 150 adds an additional n number of possible interactions and chains.

The supporting data architecture platform 140 of the framework 100 of the present invention may also leverage a retrieval augmented generation (RAG) architecture 146 to analyze structured, unstructured, and temporal data within the user-designated files 111. Retrieval-augmented generation (RAG) is a process of optimizing the output of a language model 144 that enables extension to specific domains or to a private data sets among user-designated files 111, without having to retrain a model that has been augmented.

Without RAG, a language model 144 takes user data and creates a response based on information that it already knows. With the RAG architecture 146, the framework 100 is able to extract relevant information from structured data portions of private data sets in the user-designated files 111 to create additional contextualized content 160 that may then be added to the augmented language model 162. The RAG architecture 146 enables numerical information—in both structured and unstructured portions of private data sets—to be included in the contextualized content 160 within the framework 100, providing a richer set of information 138 for the augmented language model 164. The RAG architecture 146 also further enables, as noted above, the augmented language model 164 to remain privately-hosted in that it does not need to be re-trained external to the artificial intelligence-based agent 150 or framework 100.

The application of a RAG architecture 146 to the private data sets of users 120 also enables the artificial intelligence-based agents 150 to reduce the possibility of hallucinations or incorrect answers to prompts 164. Regardless of whether directed at structured data, unstructured data, or combinations of both in such private data sets, the application of a RAG architecture 146 improves the outcomes generated in defined, domain-specific outputs 124.

An effective RAG application enables location of information relevant to the user's prompt 164 and supplies that information to the augmented language model 162. As noted herein, the framework 100 identifies text relevant to the user's prompt extracting the text therein in a way that preserves structured information such as tables of data; the final text is chunked into snippets of text, and an embedding vector for a language model 144 is calculated for each document chunk and stored. These embeddings are later accessed to easily recall snippets from documents that are relevant to prompts 164.

While transformer models (such as large language models) perform very well at providing coherent and thorough responses to user prompts, they are also suffer from reliability issues. This is because LLMs often respond with incorrect or fabricated answers, known as hallucinations, This occurs because an LLM, by itself, does not know anything that happened after it has been trained, and importantly in the context of the present invention, lacks access to information in private data sets. On a general level, attempts to address this issue may involve providing the LLM with the information it needs to address the user's prompt; but current approaches to doing this are only able to provide the LLM with just a few pages of documents, and therefore very limited. But where large scale private data sets in a plurality of user-designated files 111 are being analyzed, the RAG architecture 146 of the framework 100, when applied thereto, provides an augmented language model 164 with additional information to reduce the possibility of these hallucinations.

Implementation of a RAG architecture 146 with private data sets in user-designated files 111 reductions in hallucinations and incorrect responses to prompts 164 in a number of ways. For example, implementation of a retrieval component such as RAG architecture 146 that searches through private or domain-specific datasets provides access to specific knowledge that allows the augmented language model 162 to pull in more accurate and contextually relevant information for both the prompt 164 and the defined, domain-specific output 124. This means that instead of relying solely on potentially vague or generalized knowledge encoded with a language model's parameters, the augmented language model 162 has access to detailed, up-to-date, and domain-specific information directly from the set of information 138 contained within the private data set(s) of the user 120.

The retrieval process in the use of RAG architecture 146 provides contextual relevance (domain-specificity) which helps ensure that the information the augmented language model 162 uses to generate responses is highly relevant to the specific query or context. This reduces the likelihood of generating responses based on incorrect or generalized data that might not fit the specific scenario being addressed.

Still further, use of a RAG architecture 146 in the framework 100 provides for a reduction in ambiguity. When the artificial intelligence-based agent 150 retrieves information from a curated dataset, it has access to more precise data, which helps clarify ambiguous or complex queries. This reduces the chance of the augmented language model 162 making up details or providing misleading answers.

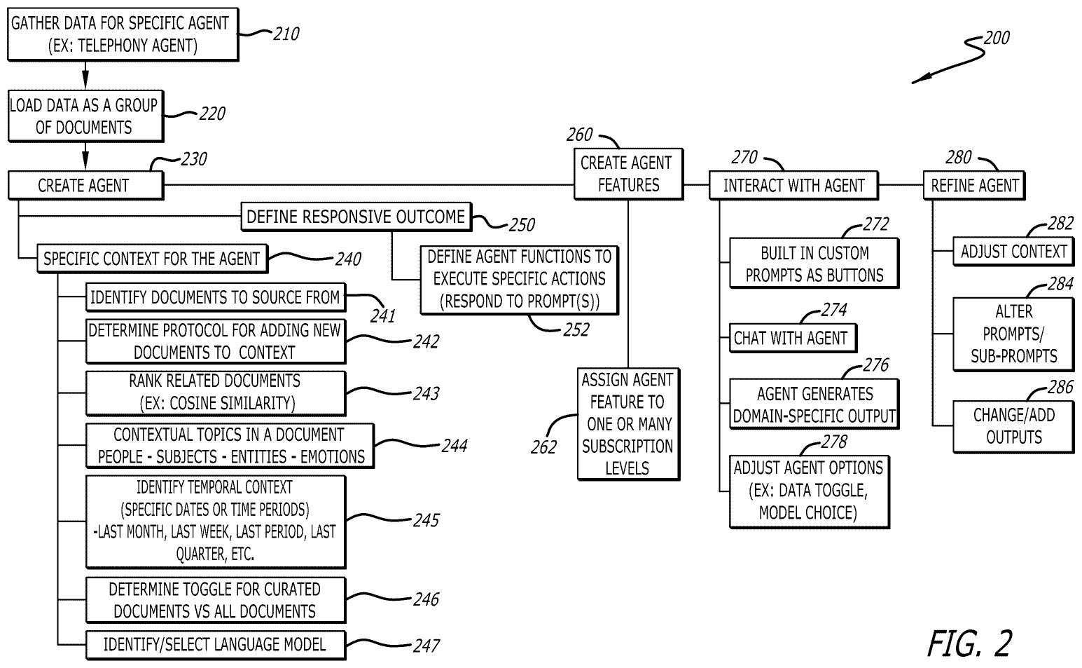

An artificial intelligence-based agent 150 within the framework 100 may be instantiated and deployed, in an exemplary implementation thereof, according to a generalized workflow 200 according to the diagram of FIG. 2. In this workflow 200, the framework 100 gathers data 210 for a specific agent (for example, a telephony agent). This data is then loaded 220 as a group of documents that are defined by a user at least according to the type of agent and its intended function(s).

The workflow 200 proceeds with creation 230 of an artificial intelligence-based agent The creation 230 of an artificial intelligence-based agent 150 includes both identifying a specific context 240 for the artificial intelligence-based agent 150, and define one or more responsive outputs 250. Together, these aspects of the workflow 200—identifying context 240 and defining a responsive output 250—create the domain-specificity in the defined, domain-specific output 124 of the specific artificial intelligence-based agent 150.

Identifying a specific context 240 for an artificial intelligence-based agent 150 may involve several issues. For example, the workflow 200 identifies documents 241 comprising the one or more user-designated files 111 that provide the information sources for the artificial intelligence-based agent 150. Identifying a specific context 240 may also involve determining a protocol 242 for adding new documents to the context, as the specific agent 150 being created 230 may have documents added periodically or continually. Regardless, these documents may be ranked 243 according to their relation with each other, for example according to a cosine similarity. This allows for the group of documents 220 to be contextualized according to various characteristics, such as for example people, topics, entities, emotions, etc. Identifying a specific context 240 may also involve identifying a temporal context 245. For example, this may involve identifying specific time periods (such as last month, last week, last period, last quarter, etc.).

Further, identifying a specific context 240 may also involve determining a toggle 246 for curated documents against all documents. This allows for the specific artificial intelligence-based agent 150 to be further contextualized based on a weighting of information among the group of documents 220, so that curated documents (at least where one or both of topics 244 and temporality 245 have been contextualized, and documents have been ranked 243) may be assigned greater authority for the defined responsive output 250 being modeled. Finally, the identifying a specific context 240 may include identifying, selecting, or assigning a language model 144 for the specific artificial intelligence-based agent 150 (or a combination of language models 144). This is due to some language models 144 being more relevant to particular types of documents (or content thereof) among the user-designed files 111, and/or more relevant to the defined, domain-specific output 124 of the artificial intelligence-based agent 150.

The workflow 200 also includes defining agent functions 252 for the responsive output 250 to achieve the defined, domain-specific output 124. Agent functions define the steps involved in performing the defined, domain-specific output 124. This may include code for executing specific actions 192 or any other type of responsive output 250 of the one or more prompts 164 that are applied to augmented models 162 in the framework 100, and may also include protocols for interacting with external systems 195, such as for example actuating external devices 193. It is to be understood that many exemplary outcomes 190 embodying such defined, domain-specific outputs 124 are possible and within the scope of the present invention, and therefore neither the claims nor this disclosure are to be limited to any specific example of either a responsive output 250 or defined, domain-specific output 124 of an artificial intelligence-based agent 150 discussed herein. It is to be further understood that an artificial intelligence-based agent 150 according to the present invention may have any type of defined, domain-specific output 124, and that workflow 200 enables definition of any type of responsive output 250 to achieve such a defined, domain-specific output 124.

The workflow 200 may also include creating agent features 260. Each artificial intelligence-based agent 150 may have different features 260, for example depending on the defined agent functions 150 and the defined, domain-specific output 124. These features 260 may assigned within each artificial intelligence-based agent 150 according to one or many subscription levels 262.

The workflow 200 may also include defining approaches to interaction 270 with each artificial intelligence-based agent 150. Each such artificial intelligence-based agent 150 may have one or more interfaces 170 through which they may be interacted with. For example, an artificial intelligence-based agent 150 may be configured with built-in, custom prompts 272, for example as “radio” buttons on an interface 170. A chat feature 274 may also be configured, such that a user 120 may converse with an artificial intelligence-based agent 150 via a chat function on the interface 170. Still further, a user may interact 270 to generate 276 their own domain-specific output 124 via an interface 170. This may occur, for example, through a feature on such an interface 170 that allows the user 120 to adjust agent options 278. Adjusting agent options 278 may also include features that allow a user 120 to change a data toggle or choose a specific language model 144.

The workflow 200 also enables an artificial intelligence-based agent 150 to be refined 280. Refining 280 an artificial intelligence-based agent 150 includes adjusting context 282—this may be accomplished by refining 280 the characteristics of a specific context 240 discussed above. Refining 280 an artificial intelligence-based agent 150 may also include altering 284 or adjusting the prompts 164 (and any nested or sub-prompts), as well as re-defining, changing, adding or deleting a domain-specific output 124 by re-defining a responsive output 250 within the workflow 200.

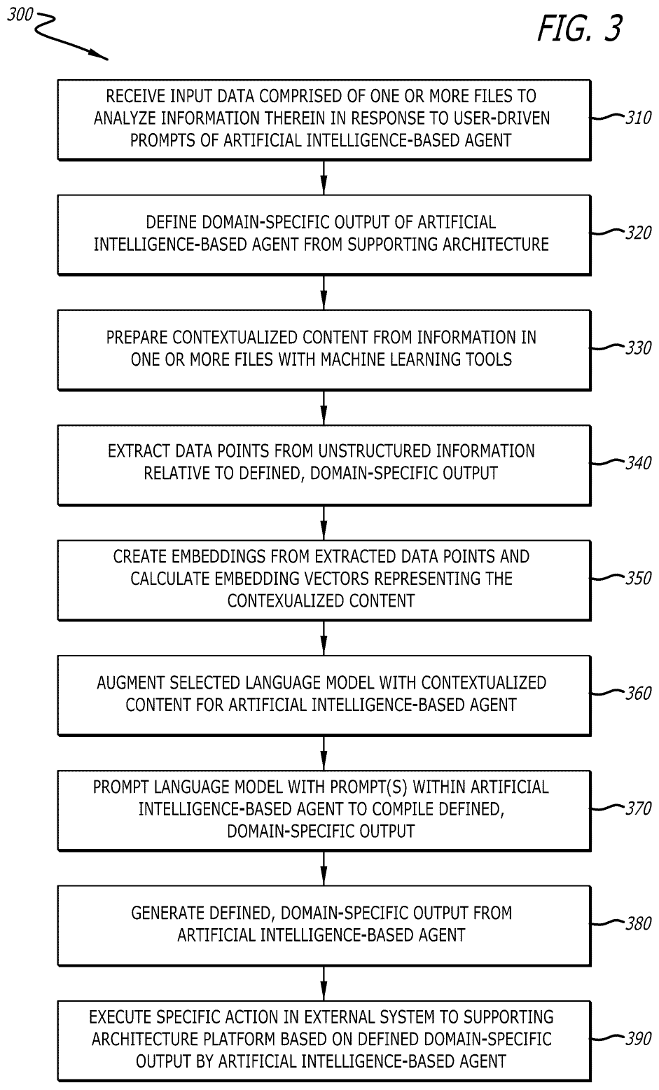

FIG. 3 is a flow chart illustrating steps in a process 300 for deploying an artificial intelligence-based agent 150 according to another embodiment of the present invention. In the process 300 of FIG. 3, input data 110 comprised of one or more user-designated files 111 is received at step 310 to analyze the set(s) of information 138 contained therein within an artificial intelligence-based agent 150. Each artificial intelligence-based agent 150 as noted herein analyzes the input data 110 in one or more prompts 164 of an augmented language model 162. The process 300 includes a mechanism that allows a user 120 to define a domain-specific output 124 of the artificial intelligence-based agent 150 and the supporting data architecture platform 140. The domain-specific output 124 may be defined as part of the input data 110 provided by the user 120, for example via an interface 170.

At step 330, the process 300 prepares contextualized content 160 from set(s) of information 138 in the user-designated files 111. This is accomplished using machine learning tools 142 within the supporting data architecture platform 140. The machine learning tools 142 extract data points from unstructured information at step 340, relative to the defined, domain-specific output 124. At step 350, the machine learning tools 142 are applied within the framework 100 and process 300 to create embeddings from extracted data points, and calculate embedding vectors that represent the contextualized content 160.

The process 300 continues with augmenting a language model 162 at step 360 with the contextualized content 160. The artificial intelligence-based agent 150 is thus ready for prompting at step 370; in this step, the process 300 applies one or more prompts 164 within the artificial intelligence-based agent 150 to drive functions that compile and generate the defined, domain-specific output 124.

At step 380, the process 300 generates the defined, domain-specific output 124 from the artificial intelligence-based agent 150, and delivers the defined, domain-specific output 124 in a manner previously-defined by the user 120. At step 390 the process 300 may execute one or more specific actions 192 (or some other form of the defined, domain-specific output 124). This may include executing a specific action 192 at or within an environment that is an external system 195 to the supporting data architecture platform 140. This may also be previously defined by the user 120 as part of the defined, domain-specific output 124.

The framework 100 may be implemented in many ways. In one embodiment of the present invention, the supporting data architecture platform 140 may be thought of as including both server-side components and client-side components for implementing the artificial intelligence-based agents 150, and utilizing language models 162 for application within such artificial intelligence-based agents 150, to generate the defined, domain-specific output 124 based on contextualized content 160 from designated user files 111. The present invention may therefore be implemented in a manner that includes input data 110, processing of such input data 110 in conjunction with language models 144 at least by analyzing instructions in one or more prompts 164, and generating outputs 124 that represent domain-specific contextualizations of the user's data.

In one embodiment of the present invention, on a server side, the supporting data architecture platform 140 gathers the user-designated files 111 (such as documents, video files, audio files), and any other types of files desired by the user 120, and regardless of where such files are stored or accessed from. These collective documents may be initially processed to perform initial functions that prepare them for subsequent functions or handling within the supporting data architecture platform 140 (such as transcription, diarization with speaker identification, and then summarization), and also infused with any other platform features selected by the user (for example, assigned with detected emotions). All files may then be structured with various general identifiers (date, type, user, document name, and document ID) and these general identifiers may be stored in a separate database table.

Continuing with this embodiment, one or more processors on the server side of the supporting data architecture platform 140 then begin compiling information such as document title and text chunk from each document in the user-designated files 111, and create individual embeddings for each document based on the text chunk for the augmented language model 162. A database may be utilized with these processors to govern when the processors perform these tasks for documents. Individual embeddings for text chunks are then used to obtain embedding vectors from the large language model, and then stored with a vector database to associate these embedding vectors with a text chunk and a document ID for each document. In a vector database, each entry may have a chunk (text), vector embedding and a document ID which it belongs to, along with a unique key for each entry.

Regardless, all of these tasks on the server side happen once per document; however, it is to be noted that whenever underlying text in the document is created or updated, the text needs to be re-chunkified and embeddings recalculated. Every time a document is edited, it is marked accordingly so that each embedding and chunk can also be updated. In effect this means that a modified document goes through the pipeline described above again; alternatively, only a few chunks may be updated. Where APIs are utilized to communicate with language models 162, the APIs transfer individual embeddings for text chunks when the language model 162 is accessed by a user 120 on the client side. To be more specific, when an artificial intelligence-based agent 150 is prompted (or when a user 120 poses a question), the supporting data architecture platform 140 of the present invention chunkifies the text, calculates embedding vectors for that prompt, then performs a similarity search within the vector database to find relevant embeddings to supply as context to the augmented language model 162. This prompt, complete with contextualized context 160 representing sets of information 138 in the documents in the user-designated files 111, is sent to the LLM via an API call.

A chunk is a section of the document which is converted into text format. Each chunk may be a specified number of words, but the chunk size will vary depending on the context and amount of information needed to be captured. Embeddings are a different representation of text, in mathematical form—a vector, which is an array of data representing the original chunk of text. Embeddings may be generated depending, at least in part, on the type of language model 144 being utilized. Embeddings are a list of numbers (vectors) extracted or derived from the text in the chunk. Each method of embedding has a set size, and is not affected by how many words are passed in.

An embedding is also a mapping of a discrete variable to a vector of continuous numbers. In neural networks, embeddings are continuous vector representations of these discrete variables. Neural network embeddings reduce the dimensionality of variables, and enable a meaningful representation of variable categories in the transformed space. They also enable the finding of nearest neighbors in the embedding space. Embeddings therefore may be also used for inputs to neural networks among the machine learning tools 142 for a supervised task that looks for similarities in the embedding space.

DynamoDB is one database approach that may be used to compile data and metadata produced at each step in the processing pipeline of the supporting data architecture platform 140 for the artificial intelligence-based agents 150; it may also be used as a message broker to start the next processing step. Regardless of the approach used or specific type of environment in the supporting data architecture platform 140, the processing pipeline takes user-designated files 111 (for example, mp4 recordings of meetings, podcasts, YouTube videos) and analyzes them, generating a handful of data and metadata therefrom (in transcriptions, diarization, etc.). The supporting data architecture platform 140 takes generated data and metadata from the user-designated files 111, and creates a pipeline step that transcodes this information to a format that can be ingested by augmented language models 162 (text chunk embeddings). The supporting data architecture platform 140 then uses the embeddings for the set of information in the documents comprising the user-designated files 111 as the contextualized context 160 for the augmented language model 162 for and artificial intelligence-based agent 150.

In a further embodiment of the present invention, the client side of the supporting data architecture platform 140 provides for real-time interaction between a user 120 and the artificial intelligence-based agent 150, where such a feature is enabled (in effect, a chatbot feature). In such a feature, users 120 may pose their own prompts 164 of the artificial intelligence-based agent 150 to ask questions via a front-end interface 170. The real-time interaction occurs using a native application or other such interface 170 that supports entry of prompts for the artificial intelligence-based agent 150.

In this further embodiment, the supporting data architecture platform 140 creates a further embedding from the question posed by the user 120. The supporting data architecture platform 140 then filters documents from the user-designated files 111 based on the user's access to only that user's available media library (and whatever other information the user designates and has access to, to form his or her universe of documents to be analyzed).

The supporting data architecture platform 140 then performs an index lookup on filtered embeddings in the vector database and retrieves plain text chunks based on an embeddings similarity. The index lookup may be a form of database search, in which a nearest neighbor approach is used to analyze chunks that are closest to what has been asked of the artificial intelligence-based agent 150. This is in effect a similarity search between one embedding vector and a data store of other embedding vectors. To further clarify with an example, consider an engine for analyzing telephony data: give it a voice recording of a telephone conversation with parameters for how to analyze the telephone conversation, and it generates an embedding vector which is a representation describing portions of that voice recording according to those parameters. It then searches for similar portions of other voice recordings in a vector datastore and returns results that are highly similar. Such an engine therefore enables comparisons of telephone conversations across time, which further enables analytics based on those telephone conversations.

The embeddings similarity may be performed using a cosine similarity, which is a mathematical implementation of an approach such as nearest neighbor that determines how close the vectors (embeddings) are to each other. The supporting data architecture platform 140 compares the question embeddings with all the filtered chunks/documents to get the most relevant list of chunks. Every embedding is also a vector by itself, represented as a series of numbers.

The original prompt 164 posed by the user 120 is now contextualized with supplemental data for further processing of the prompt 164. The supplemental data that contextualizes the prompt 164 represents the plain text chunks based on the embeddings similarity. The prompt 164 is then passed together with the chunks to the augmented language model 162. The answer is retrieved either provided to the user 120 (on an interface 170), or compiled as part of the defined, domain-specific output 124.

The conversation or prompt 164 history may also be saved in a backend database of the supporting data architecture platform 140, together with answer pairs and other information such as timestamps. In this embodiment, every time a set number of new prompts 164 are presented, that history is also passed to that portion of the supporting data architecture platform 140 discussed above responsible for creating embeddings from the prompt 164. In this manner, the new embeddings created from the new question can be additionally contextualized with metadata representing a conversation history saved from the prior interactions with the augmented language model 162. This enables the artificial intelligence-based agent 150 to be persistent, remembering the user's history of prompts 164 and outcomes of searches initiated by those prompts 164.

The threshold for the number of queries posed in a prompt 164 asked before a history is passed to the supporting data architecture platform 140 may change, depending at least upon the flexibility of the artificial intelligence-based agent 150 and ability to learn over time, as well as the number of tokens need for the augmented language model 162 (which relates to the amount of information that can be passed through the API).

The supporting data architecture platform 140, and also the entire framework 100 of the present invention, ensures that no confidential information from the user 120 ever leaves their system, and therefore no confidential information presented in a prompt 164 using the artificial intelligence-based agent 150 will be passed to the language model 144 itself. This is true at least in part because of the privately-hosted nature of the augmented language model 162, and selection of the language model 144 itself that is used, as the present invention enables selection of particular language models 144 which enable hosting in a private, secure operating environment.

The choice of language model 144 also influences the underlying processing hardware that is required. The framework 100 of the present also allows for language models 144 to be selected where CPU-based processing is possible, rather than GPU-based processing. This enables a fully localized approach, where the private hosting of the language model 144 occurs entirely within a local device using on-board CPUs. This further ensures that no confidential information leaves the user's system. It also ensures that native artificial intelligence-based agents 150 may be developed on such devices, and using local device-specific operating systems, such that each artificial intelligence-based agent 150 may implement its own privately-hosted language model environment for processing information such as prompts 164.

The supporting data architecture platform 140 and framework 100 also enable document provenance within the user-designated files 111. An embeddings search returns similar embeddings relevant to a search query presented by a prompt 164, which is then linked to particular documents. From the supporting data architecture platform 140, the framework 100 may not only provide an answer to a prompt 164, but also provide a list of documents that directly relate to a question-answer pair. A user 120 may thus look through relevant documents as provenance for the answer to the prompt 164 they have made to the artificial intelligence-based agent 150.

Still further, the supporting data architecture platform 140 enables natural language-based document semantic search, which directly relates to such document provenance. For example, the interface 170 incorporating the chatbot function of the artificial intelligence-based agent 150 may include a search bar; the user 120 writes in the desired search terms, and because the present invention enables document provenance, the chatbot returns all documents relevant to the search.

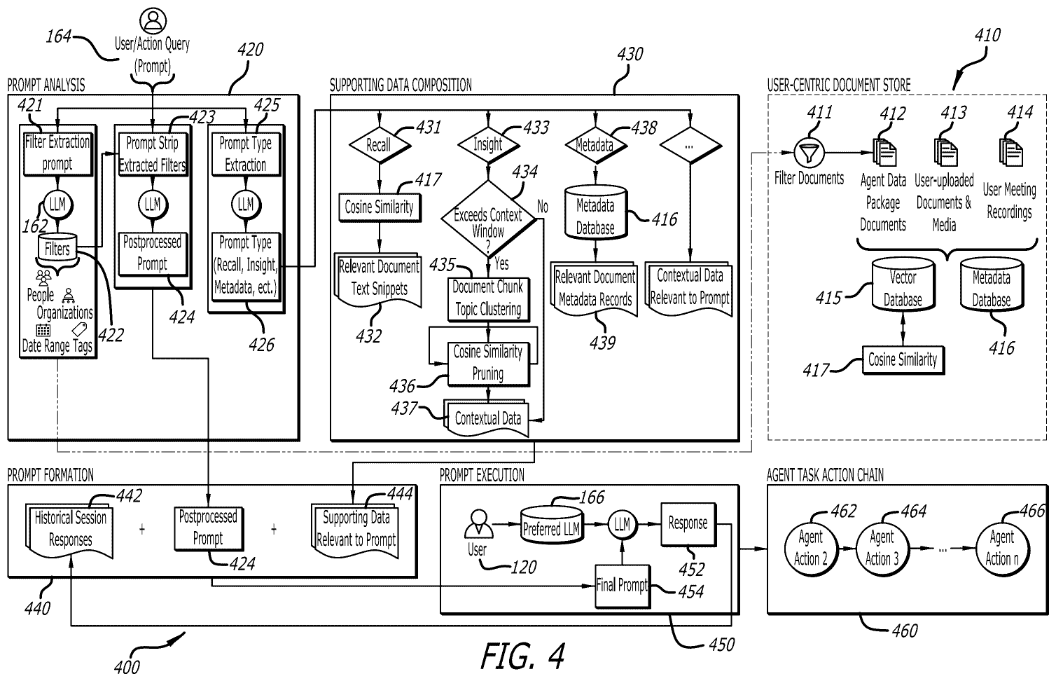

FIG. 4 is a data flow diagram for an artificial intelligence-based agent 150, according to one embodiment of the present invention. FIG. 4 illustrates a process 400 for internal processing of user-designated files 111 in response to prompts 164.

In this process 400, a user-centric document store 410 represents a data lake 137 for the user-designated files 111 for a particular user 120 of an artificial intelligence-based agent 150. The user-centric document store 410 is the set of documents that linked to a user 120 account, and includes data packages 412 used by a particular artificial intelligence-based agent 150 for that user-centric document store 410 (such as for example user-uploaded documents and media 413 (corporate policy documents, presentations, recordings, pdfs), and user meeting records 414 (collected by a bot that attends virtual meetings on a user's behalf. If the document in the user-designated files 111 in the user-centric document store 410 is a media file, it is transcribed and diarized into text. Alternatively if a document is for example a Portable Document Format (PDF) file, the framework 100 extracts the text therein in a way that preserves structured information such as tables of data. Regardless of source, the final text is chunked into snippets of text, and an embedding vector for a language model 144 is calculated for each document chunk and stored in a vector database 415. These embeddings are used later on to easily recall snippets from documents that are relevant to prompts 164. The framework 100 also stores metadata (e.g., meeting time, relevant people, etc.) for each document in a metadata database 416.

The process 400 then performs a prompt analysis 420. A user 120 enters information as a chat, or starts a task, via the artificial intelligence-based agent 150, which begins by issuing a prompt 164. In this embodiment, for each of the below steps in the prompt analysis 420, the framework 100 issues an internal prompt based on the original prompt 164 to extract information about the original prompt 164 and operate in different ways depending on what the artificial intelligence-based agent 150 determines about the query or task being performed. The artificial intelligence-based 150 therefore asks a series of questions about the original prompt 164: for example, what time period are you asking about? are you asking for specific facts or wanting me to summarize some information, or something else?

The framework 100 performs a filter extraction 421 on the prompt 164. The framework 100 extracts any filters 422 from the prompt 164 to curtail the document search space when gathering supporting data to provide context for the query represented by the prompt 164. The framework 100 looks for entities the user 120 might know about in their related knowledge graph, such as people, organizations, and tags. The framework 100 also looks for temporality in mentioned date ranges or periods, such as “last quarter” or “in the last week”. Whenever the framework 100 goes to look up data from documents to answer a query in a prompt 164, these filters 422 are first applied to the search space, for both performance as well as quality of results returned. Filters 422 enable filtered documents 411 for the user-centric document store 410.

The process 400 then strips 423 filters 422 identified in the filter extraction 421 from the prompt 164. Once the artificial intelligence-based agent 150 knows the filters 422 to apply to the search space, it performs this strip 423 function to remove this information out of the original prompt 164, and the artificial intelligence-based agent 150 accomplishes this by running another prompt. For example, the query “what issues has my sales team been experiencing in the last quarter?” would result in a date filter of “last quarter” and the resulting post-processed prompt 424 for the artificial intelligence-based agent 150 with the filter 422 stripped would be “what issues has my sales team been experiencing?”.

The artificial intelligence-based agent 150 then performs a prompt type extraction 425 to determine the type 426 of the prompt 164 by classifying it into a few different buckets (multi-class classification): recall 431, insight 433, metadata 438, and more (to create contextualized data relevant to the prompt 164). Each type 426 of prompt 164 proceeds along its own processing flow which changes: (i) how it grabs data, (ii) what data it grabs, and (iii) how it processes this data. Each of these flows forms a high-quality set of data to support the user's original prompt 164 to answer queries in such a prompt 164 or to accomplish tasks requested of the artificial intelligence-based agent 150. This also provides the foundation of a high-quality RAG architecture 146, by injecting the right data to support the prompt 164.

The process 400 then proceeds with supporting data composition 430. The framework 100 applies this supporting data composition 430 step to get the best supporting data possible to provide alongside the original prompt 164 for the artificial intelligence-based agent 150. Based on the prompt type 426 extracted in the previous step, the framework 100 may operate differently.

In recall 431, type classification for this supporting data composition 430 step generally does not require extensive processing. Recall 431 is utilized to look up key details from a pool of documents or data that are relevant to the prompt 164, so that the artificial intelligence-based agent 150 can either make inferences about the recalled data or regurgitate it to answer a query. For example, a 150 page corporate annual report is upload, and the artificial intelligence-based agent 150 is prompted with “what percent of gross revenue came from sales of product y” (y being a product of the corporation). The framework 100 calculates the embedding vector for the query in the prompt 164, and then searches through all the precalculated embedding vectors in the vector database 415 for the text in the annual report to find text snippets with high cosine similarity 417. These chunks of text would indicate portions of the document where revenue from product y were mentioned so that the query may be answered.

Consider a further example prompt 164: “What are our end of year sales targets for agents?”. This is a straightforward classification of the prompt type 426 from the immediate, basic parameters of the prompt 164 (as is the example in the paragraph above). The framework 100 proceeds calculates an embedding vector for the prompt 164, and then runs a cosine similarity 417 across the vector database 415 to get the top x document text snippets 432 (after filtering) to answer the query in the prompt 164.

Insight 433 for type classification in the supporting data composition 430 step requires additional analysis due to the more complex nature of the prompt 164. Consider the example prompt 164: “Summarize this podcast about climate change and write a haiku about the author's stance on fossil fuels”. If the podcast is very short and the text fits in a context window for the augmented language model 162 being used, then classification of the prompt type requires no further processing. If however the podcast extensive—for example, it is an hour long with a long transcript—this information is compressed to fit into the context window 434 of the augmented language model 162. The framework 100 chunks the document text into chunks as normal, and calculates embedding vectors for each chunk, but then clusters 435 these embeddings. This is because each natural cluster represents a core idea about the document. The framework 100 calculates the centroid of each cluster 435 and then from this centroid, computes the Euclidean distance with every embedding vector in the cluster 435 and chooses the top x embeddings. This effectively compresses the text of the document while still maintaining important concepts and ideas explored in the document. Then the framework 100 checks if it is within the context window of the augmented language model 162. If is still beyond this context window, the framework 100 iteratively prunes 436 the text using cosine similarity of each embedding against the embedding vector of the input prompt 164. The lowest similarity document chunk is discarded, and so on, until the final supporting data can fit within the available context window of the language model 144 alongside the prompt 164. This creates the contextual data 437 for the prompt 164.

For classification of metadata 438, consider the example prompt: “When was my last meeting with Jim?”. These types 426 of prompts 164 are queries regarding the data state of the underlying data architecture platform 140 or metadata of documents the user 120 has access to in the underlying data architecture platform 140. For these queries the artificial intelligence-based agent 150 references the relational database of document metadata (the metadata database 416) consisting of structured and unstructured data of relevant documents 439 with metadata records to inject alongside the prompt 164. This includes items such as recent meetings, documents, uploads along with their metadata such as participants, important dates, tags, etc.

In prompt formation 440, the underlying data architecture platform 140 constructs a post-processed prompt 424 for the augmented language model 162. The framework 100 first gathers any previous prompt, and response pairs in the user's session or task action chain, and determines whether to also include this data as supporting data 444 relevant to the post-processed prompt 424. If the context window 434 length of the augmented language model 162 is exceeded, the framework 100 prunes historical session response 442 down until n=1. The framework 100 then concatenates the text of the post-processed prompt 424 (after being stripped 423 of filters 422). Then the framework 100 concatenates the compiled supporting data 444.

The process 400 then performs prompt execution 450. The underlying data architecture platform 140 allows prompts 164 to be run on any type of language model 144, considering specifics of the language model 144 required for execution, such as context window length. Each user 120 may set the preferred augmented language model 162 for processing of contextualized content 160. If this is a third-party model, the formed, post-processed prompt 424 (shown as final prompt 454), including historical interactions/historical session responses 442 and supporting data 444 is sent over an API 172 for processing, and the response 452 of the augmented language model 162 is returned to the user 120 (and/or generated as a defined, domain-specific output 124). If an open-source, self-hosted language model 144 is selected, it is processed on the internal GPU cluster.

If the user 120 is executing a task as a defined, domain-specific output 124 which is comprised of a series of sequential actions in an agent task action chain 460, then the output of a first agent action 462 is piped to the input of the second agent action 464, and so on, forming a cascading chain reaction of n agent actions 466. The output of each such agent action in the n agent actions 466 may comprise a defined, domain-specific output 124 of an artificial intelligence-based agent 150.

It is to be understood that many types of defined, domain-specific outputs 124 based on contextualized content 160 from private data sets are possible and within the scope of the present invention. Therefore, neither the claims, this specification, nor the present invention, shall be limited to any particular type of domain-specific output 124 or application or use case thereof that is expressed herein.

The framework 100 generates output data 180 which is utilized to generate the defined, domain-specific output 124, and there are many exemplary outcomes 190 leveraging this output data 180 to embody the defined, domain-specific output 124. For example, an artificial intelligence-based agent 150 may generate documents or files 191 that are delivered to external systems 195. For example, one type of defined, domain-specific output 124 as a document or file 191 may be a short—such as a text, video, or audio file—that may be shared with external systems 195. Examples of external systems 195 in this context include a social media account of a user 120, or a particular type of external system 195 such as an application that delivers education content, where a short clip of a lecture is desired to be sent to external users. In such an output, the framework 100 automatically generates a file representing a short clip of a portion of a document based on a user instruction in defining a domain-specific output 124, and exports that file to the destination or system designated by the user 120.

Another example of an outcome 190 embodying a defined, domain-specific output 124 is an actuation 193 of an external device or system 193. This may be accomplished by generating an instruction 194 for such an actuation 193 by an artificial intelligence-based agent 150. The framework 100 may therefore be configured to analyze information in a private data sets and take action to an external system 195 that automatically actuates some element of that external system 195—whether it be creating a document or file 191, or manipulating a mechanical device in some manner (such as for instructing a robot within a laboratory environment). The specific action 192 taken in response to a defined, domain-specific output 124 may therefore be within an external system 195 itself, and the framework 100 may leverage one or more APIs 172 for accomplishing such an outcome.

One example of an external system 195 is a customer relationship management system 196. An artificial intelligence-based agent 150 may be configured to execute a specific action 192 in the form of a write function to a customer relationship management system 196 as a defined, domain-specific output 124.

It is to be understood that many examples of specific actions 192, external systems 195, and defined, domain-specific outputs 124 are possible and within the scope of the present invention, and that many additional applications and use cases 197 are possible. For example, the desired output 124 may be a text string generated in the form of an automatic post to a messaging platform, representing a summary of content the user 120 has designated. In still a further example, the output data 180 representing the defined, domain-specific output 124 may be an instruction 194 to a further large language model (or small language model) to perform a particular task; this may include a string of characters that serves as a natural-language instruction to develop, for example, an advertising campaign, a new curriculum for particular students, an initial draft of an article or book, notes for a song, or any other content, based on the user-designated files 111. In a more specific example of this, a user 120 performs a search using the artificial intelligence-based agent 150 of the present invention to locate and summarize all instances within the user-designated files 111 where a new idea for an invention was discussed. The framework 100 may summarize all of those instances and generate an instruction for an augmented language model 162 to prepare an initial draft of a patent application for the invention that was discussed, and return the draft to the user 120.

One example of an artificial intelligence-based agent 150 is an Auto-Grade agent. In an Auto-Grade agent, user-designated files 111 may include question text, teacher-provided answer key, text of student answers to each question, and related source educational material as input data 110. If the source material includes media files such as audio files 114 or video files 115, the framework 100 first transcribes those to transform the source material to text. A defined, domain-specific output 124 of the Auto-Grade agent in this example may include grade, and justification of the grade, to each student's answer to each question.

In this example, each set of questions are typically related to some source material, such as a textbook chapter or video. These data sources are often proprietary and likely not provided in the generalized training data for the language model 144 being used. For each question, the artificial intelligence-based agent 150 forms a prompt 164 that includes the question, the answer, the teacher-provided answer key, grading output constraints (e.g., grade must be between 0 and 1 inclusive, partial marks are allowed), instructions for how to provide justifications for provided grades, and include any relevant supporting data from the related educational material. If student answers are being batch processed (as human teachers often do), the artificial intelligence-based agent 150 packs as many student answers into one prompt as possible, asking the augmented language model 162 to provide a grade and justification to each student answer in a structured format such as JSON. This batching technique is predominantly for speed and economic efficiency.

Packing all of this data into a prompt 164 requires balancing because of the limited context window length—a prompt 164 for a language model can only take in as input a fixed number of tokens. If supporting data needs to be compressed to perform this balancing, RAG techniques such as cosine similarity 417 are implemented with the prompt embedding vector to prune 436 irrelevant data. The artificial intelligence-based agent 150 may also decrease the batch size (number of student responses being processed at once) to ensure for highest efficiency with the limited context window availability.

There are many types of machine learning techniques that may be implemented within the supporting data architecture platform 140 and the framework 100. Graph data models are one example of machine learning tools 142. Graph data models leverage a variety of machine learning algorithms to enhance their functionality in knowledge graph implementations involving artificial intelligence models. These algorithms assist in uncovering insights and patterns within interconnected data to enhance performance of artificial intelligence models such as language models 162. Machine learning algorithms may be integrated with knowledge graphs for tasks such as entity classification, sentiment analysis, and predictive modeling. Some specific machine learning-based algorithms that may be used include link prediction algorithms, such as node embedding methods, are used to predict missing relationships or edges between entities in the knowledge graph. These algorithms learn representations of nodes (entities) in a way that encodes their structural and semantic properties, enabling the identification of potential connections that may not be explicitly present in the data.

Graph traversal algorithms such as Breadth-First Search (BFS) and Depth-First Search (DFS) may be utilized for graph traversal. These types of algorithms help to navigate the knowledge graph to discover connected entities, uncovering paths and relationships that provide valuable insights into the data. Community detection algorithms, such as Louvain or Modularity-based methods, may also be applied to identify densely-connected clusters or communities within the knowledge graph. These communities often represent groups of related entities or topics, aiding in the organization and categorization of knowledge when applied to an output of a language model 162 to improve the accuracy of such an output. Centrality algorithms may also be used to determine the importance or influence of nodes within the graph. These may be used to identify key entities or hubs in the knowledge graph, which may be valuable for recommendation systems or understanding the significance of different data points. Algorithms specific to semantic similarity and natural language processing (NLP) techniques enable word embeddings to be integrated with knowledge graphs to capture semantic relationships between entities and textual information. This enables the extraction of knowledge from unstructured text data and its integration into the graph.

Knowledge graph embeddings algorithms may be used to transform entities and relationships into continuous vector representations. These embeddings enable mathematical operations on the graph structure and support various tasks of AI tools such as language models 162, such as entity classification, relation prediction, and question answering. Other algorithms for specifically improving augmentations of language models 162 include graph neural networks (GNNs). GNNs are deep learning models designed for graph-structured data. They leverage message passing and aggregation mechanisms to perform tasks like node classification, link prediction, and graph classification. GNNs are examples of tools for linking knowledge graph models and large language models, by incorporating both structural and attribute information from the knowledge graph into the AI models 160.

Machine learning tools 142 in the framework 100 of the present invention may also include, as noted above, applications of neural networks. Neural networks generally are comprised of nodes, which are computational units having one or more biased input/output connections. Such biased connections act as transfer (or activation) functions that combine inputs and outputs in some way. Nodes are organized into multiple layers that form the neural network. There are many types of neural networks, which are computing systems that “learn” to perform tasks in a supervised manner, without being programmed with task-specific rules, based on examples.

Neural networks generally are based on arrays of connected, aggregated nodes (or, “neurons”) that transmit signals to each other in the multiple layers over the biased input/output connections. Connections, as noted above, are activation or transfer functions which “fire” these nodes and combine inputs according to mathematical equations or formulas. Different types of neural networks generally have different configurations of these layers of connected, aggregated nodes, but they can generally be described as an input layer, a middle or ‘hidden’ layer, and an output layer. These layers may perform different transformations on their various inputs, using different mathematical calculations or functions. Signals travel between these layers, from the input layer to the output layer via the middle layer, and may traverse layers, and nodes, multiple times.

Signals are transmitted between nodes over connections, and the output of each node is calculated in a non-linear function that sums all of the inputs to that node. Weight matrices and biases are typically applied to each node, and each connection, and these weights and biases are adjusted as the neural network processes inputs and transmits them across the nodes and connections. These weights represent increases or decreases in the strength of a signal at a particular connection. Additionally, nodes may have a threshold, such that a signal is sent only if the aggregated output at that node crosses that threshold. Weights generally represent how long an activation function takes, while biases represent when, in time, such a function starts; together, they help gradients minimize over time. At least in the case of weights, they can be initialized and change (i.e., decay) over time, as a system learns what weights should be, and how they should be adjusted. In other words, neural networks evolve as they learn, and the mathematical formulas and functions that comprise neural networks design can change over time as a system improves itself.

Neural networks can also incorporate a time delay, or feedback loop, which is calculated to generally account for temporal dependencies, to further improve the results of the modeling framework. This may be used by a particular type of neural network that accounts for timed data sequences, such as for example the Long-Short-Term-Memory (LSTM) neural network, discussed above. Feedback loops and other time delay mechanisms applied by the various mathematical functions of such a neural network are modeled after one or more temporally-relevant characteristics, and incorporate calculated weights and biases for variables depending on the input data collected and type of problem being analyzed.

Neural networks may be configured to address the problem of decay in longer time-dependent sequences in an architecture that has multiple, interactive components acting as “blocks” in place of the conventional layers of the neural network. Each of these blocks may represent a single layer in a middle layer, or may form multiple layers; regardless, each block may be thought of as representing different timesteps in a time-dependent sequence analysis of input data.

The components of such a specially-focused neural network form its internal state and include a cell, which acts as the memory portion of the block, and three regulating gates that control the flow of information inside each block: an input gate, an output gate, and a forget gate. The cell remembers values over arbitrary time intervals, by keeping track of the dependencies between elements in an input sequence, and the three gates regulate the flow of information into and out of the cell. The input gate controls the extent to which a new value flows into the cell, the forget gate controls the extent to which a value remains in the cell, and the output gate controls the extent to which the value in the cell is used to compute the output of the block. The decision-making function of these gates is often referred to as the logistic sigmoid function for computing outputs of gates in these types of neural networks. There are connections into and out of these gates, and at least the weights of these connections, which need to be learned during training, determine how the gates operate.

Inside neural network blocks, there are additional layers that perform the activation functions needed to ensure that time-dependent data sequences are properly analyzed to avoid decay. One such activation function that may be incorporated is a tan h layer, which effectively classifies input data by determining which input values are added to the internal state of the block. Input gates are a layer of sigmoid-activated nodes whose output is multiplied by inputs classified by preceding tan h layers. The effect of these activation functions is to filter any elements of the inputs that are not required, based on the values assigned to each node for the problem being analyzed, and the weights and biases applied. The weights applied to connections between these nodes can be trained to output values close to zero to switch off certain input values (or, conversely, to pass through other values). Another internal state of a block, the forget gate, is effectively a feedback loop that operates to create a layer of recurrence that further reduces the risk of decay in time-dependent input data. The forget gate helps the neural network learn which state variables should be “remembered” or “forgotten”.

Supervised learning is an application of mathematical functions in algorithms that classify input data to find specific relationships or structure therein that allow the machine learning prediction engine to efficiently produce highly accurate output data. There are many types of such algorithms for performing mathematical functions in supervised learning approaches. These include regression analysis (including the logistic regression discussed above, and polynomial regression, and many others), decision trees, Bayesian approaches such as naive Bayes, support vector machines, random forests, anomaly detection, etc.

Recurrent neural networks are a name given to types of neural networks in which connections between nodes follow a directed temporal sequence, allowing the neural network to model temporal dynamic behavior and process sequences of inputs of variable length. These types of neural networks are deployed where there is a need for recognizing, and/or acting on, such sequences. As with neural networks generally, there are many types of recurrent neural networks.

Neural networks having a recurrent architecture may also have stored, or controlled, internal states which permit storage under direct control of the neural network, making them more suitable for inputs having a temporal nature. This storage may be in the form of connections or gates which act as time delays or feedback loops that permit a node or connection to retain data that is prior in time for modeling such temporal dynamic behavior. Such controlled internal states are referred to as gated states or gated memory, and are part of long short-term memory networks (LSTMs) and gated recurrent units (GRUs), which are names of different types of recurrent neural network architectures. This type of neural network design is utilized where desired outputs of a system are motivated by the need for memory, as storage, and as noted above, where the system is designed for processing inputs that are comprised of timed data sequences. Examples of such timed data sequences include video, speech recognition, and handwriting—where processing requires an analysis of data that changes temporally. In the present invention, where output data is in the form of predicted or forecasted future state of some condition, an understanding of the influence of various events on a state over a period of time lead to more highly accurate and reliable predictions or forecasts.

Many other types of recurrent neural networks exist. These include, for example, fully recurrent neural networks, Hopfield networks, bi-directional associative memory networks, echo state networks, neural Turing machines, and many others, all of which exhibit the ability to model temporal dynamic behavior. Any instantiation of such neural networks in the present invention may include one or more of these types, and it is to be understood that neural networks applied within the machine learning prediction engine may include different ones of such types. Therefore, the present invention contemplates that many types of neural networks may be implemented, depending at least on the type of problem being analyzed.

The systems and methods of the present invention may be implemented in many different computing environments. For example, the various algorithms embodied in the data processing elements may each be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, executed on a programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. For example, it is to be understood that artificial intelligence-based agents 150 may run natively within the framework 100 and supporting data architecture platform 140, or within external systems 195, or within a cloud computing-based container running a particular workload or process. Artificial intelligence-based agents 150 may therefore be embedded either within the supporting data architecture 140, within a cloud computing environment, or within an external device itself. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method, comprising:
receiving input data comprised of one or more files representing a set of information for a defined, domain-specific output of an artificial intelligence-based agent;
analyzing the one or more files in response to at least one prompt of artificial intelligence-based agent to generate the defined, domain-specific output, by:
preparing contextualized content from the set of information in a plurality of machine learning tools within a supporting architecture platform for the artificial intelligence-based agent,
augmenting a selected language model with the contextualized content, and
prompting the selected language model within the artificial intelligence-based agent with one or more prompts, wherein the artificial intelligence-based agent generates the defined, domain-specific output based on the augmented selected language model and the contextualized content; and
wherein the artificial intelligence-based agent executes a specific action identified by the user external to the supporting architecture platform from the defined, domain-specific output.

2. The method of claim 1, further comprising providing one or more instructions to perform the specific action identified by the user to an external system.

3. The method of claim 2, wherein the specific action is executed within the external system.

4. The method of claim 2, wherein the external system is a customer relationship management system, and wherein the specific action executed is a write function of output data comprised of the defined, domain-specific output to the customer relationship management system.

5. The method of claim 1, wherein the artificial intelligence-based agent is embedded in an external system and executes the specific action within the external system.

6. The method of claim 1, wherein the specific action identified by the user external to the supporting architecture platform is an actuation of an external device.

7. The method of claim 1, wherein the one or more files comprise private data sets designated by the user, and wherein the private data sets define contextual and temporal constraints that are domain-specific for the defined, domain-specific output of the artificial intelligence-based agent.

8. The method of claim 1, wherein the plurality of native machine learning tools are configured to prepare the content in the one or more files by extracting data points from unstructured portions of the content that are relative to the defined, domain-specific output, creating individual embeddings from the data points, and calculating embedding vectors for the content.

9. The method of claim 1, further comprising implementing a retrieval-augmented generation architecture to extract information relative to the defined, domain-specific output from the one or more files, and adding information extracted by the retrieval-augmented generating architecture to the contextualized content where the set of information for the defined, domain-specific output includes one or more structured portions.

10. The method of claim 1, wherein the prompting a selected language model within the artificial intelligence-based agent with one or more prompts further comprises providing one or more verbal, written, or gestured prompts of the artificial intelligence-based agent by the user.

11. The method of claim 1, further comprising enabling a user to define a domain-specific output of the artificial intelligence-based agent for the one or more files.

12. The method of claim 1, further comprising selecting a language model, wherein the language model is selected either by a user or automatically by the artificial intelligence-based agent.

13. The method of claim 1, wherein the prompting the selected language model within the artificial intelligence-based agent with one or more prompts includes nested sub-prompts for the selected language model that are responsive to user changes to one or both of the defined, domain-specific output and the specific action.

14. A method, comprising:
contextualizing content in one or more user-designated files representing a set of information for a defined, domain-specific output of an artificial intelligence-based agent in a plurality of machine learning tools;
augmenting a selected language model with the contextualized content; and
analyzing the contextualized content within the artificial intelligence-based agent, by prompting the selected language model with one or more prompts,
wherein the artificial intelligence-based agent generates the defined, domain-specific output based on the augmented selected language model and the contextualized content, and
wherein the defined, domain-specific output of the artificial intelligence-based agent executes a specific action identified by the user external to a data architecture platform supporting the artificial intelligence-based agent.

15. The method of claim 14, wherein the defined, domain-specific output from the artificial intelligence-based agent includes one or more instructions provided to an external system to execute the specific action.

16. The method of claim 15, wherein the specific action is executed within the external system.

17. The method of claim 15, wherein the external system is a customer relationship management system, and wherein the specific action executed is a write function of output data comprised of the defined, domain-specific output to the customer relationship management system.

18. The method of claim 14, wherein the artificial intelligence-based agent is embedded in an external system and executes the specific action within the external system.

19. The method of claim 14, wherein the specific action identified by the user external to the supporting architecture platform is an actuation of an external device.

20. The method of claim 14, wherein the one or more files comprise private data sets designated by the user, and wherein the private data sets define contextual and temporal constraints that are domain-specific for the defined, domain-specific output of the artificial intelligence-based agent.

21. The method of claim 14, wherein the plurality of native machine learning tools are configured to prepare the content in the one or more files by extracting data points from unstructured portions of the content that are relative to the defined, domain-specific output, creating individual embeddings from the data points, and calculating embedding vectors for the content.

22. The method of claim 14, further comprising implementing a retrieval-augmented generation architecture to extract information relative to the defined, domain-specific output from the one or more files, and adding information extracted by the retrieval-augmented generating architecture to the contextualized content where the set of information for the defined, domain-specific output includes one or more structured portions.

23. The method of claim 14, wherein the prompting a selected language model within the artificial intelligence-based agent with one or more prompts further comprises providing one or more verbal, written, or gestured prompts of the artificial intelligence-based agent by the user.

24. The method of claim 14, further comprising enabling a user to define a domain-specific output of the artificial intelligence-based agent for the one or more files.

25. The method of claim 14, further comprising selecting a language model, wherein the language model is selected either by a user or automatically by the artificial intelligence-based agent.

26. The method of claim 14, wherein the prompting the selected language model within the artificial intelligence-based agent with one or more prompts includes nested sub-prompts for the selected language model that are responsive to user changes to one or both of the defined, domain-specific output and the specific action.

27. A system, comprising:
one or more artificial intelligence-based agents within a supporting data architecture platform, the one or more artificial intelligence-based agents configured to:
contextualize content in one or more user-designated files representing a set of information for a defined, domain-specific output of the artificial intelligence-based agent in a plurality of machine learning tools,
augment a selected language model with the contextualized content, and
analyze the contextualized content within the artificial intelligence-based agent, by prompting the selected language model with one or more prompts,
wherein the artificial intelligence-based agent generates the defined, domain-specific output based on the augmented selected language model and the contextualized content, and
wherein the defined, domain-specific output of the artificial intelligence-based agent executes a specific action identified by the user external to a data architecture platform supporting the artificial intelligence-based agent.

28. The system of claim 27, wherein the defined, domain-specific output from the artificial intelligence-based agent includes one or more instructions provided to an external system to execute the specific action.

29. The system of claim 28, wherein the specific action is executed within the external system.

30. The system of claim 28, wherein the external system is a customer relationship management system, and wherein the specific action executed is a write function of output data comprised of the defined, domain-specific output to the customer relationship management system.

31. The system of claim 27, wherein the artificial intelligence-based agent is embedded in an external system and executes the specific action within the external system.

32. The system of claim 27, wherein the specific action identified by the user external to the supporting architecture platform is an actuation of an external device.

33. The system of claim 27, wherein the one or more files comprise private data sets designated by the user, and wherein the private data sets define contextual and temporal constraints that are domain-specific for the defined, domain-specific output of the artificial intelligence-based agent.

34. The system of claim 27, wherein the plurality of native machine learning tools are configured to prepare the content in the one or more files by extracting data points from unstructured portions of the content that are relative to the defined, domain-specific output, creating individual embeddings from the data points, and calculating embedding vectors for the content.

35. The system of claim 27, further comprising implementing a retrieval-augmented generation architecture to extract information relative to the defined, domain-specific output from the one or more files, and adding information extracted by the retrieval-augmented generating architecture to the contextualized content where the set of information for the defined, domain-specific output includes one or more structured portions.

36. The system of claim 27, wherein the prompting a selected language model within the artificial intelligence-based agent with one or more prompts further comprises providing one or more verbal, written, or gestured prompts of the artificial intelligence-based agent by the user.

37. The system of claim 27, further comprising enabling a user to define a domain-specific output of the artificial intelligence-based agent for the one or more files.

38. The system of claim 27, further comprising selecting a language model, wherein the language model is selected either by a user or automatically by the artificial intelligence-based agent.

39. The method of claim 27, wherein the prompting the selected language model within the artificial intelligence-based agent with one or more prompts includes nested sub-prompts for the selected language model that are responsive to user changes to one or both of the defined, domain-specific output and the specific action.
